(19) United States
(12) Patent Application Publication
(10) Pub. No.: US 2012/0076708 A1
(43) Pub. Date: Mar. 29, 2012

(54) POROUS SEALING MATERIAL

(75) Inventors: Joseph E. Ferri, Shillington, PA (US); Kenneth P. Kreska, Shillington, PA (US)

(73) Assignee: GENERAL POLYMERIC CORPORATION, Reading, PA (US)

(21) Appl. No.: 13/236,107

(22) Filed: Sep. 19, 2011

Related U.S. Application Data
(63) Continuation of application No. 12/395,927, filed on Mar. 2, 2009, now abandoned.
(60) Provisional application No. 61/067,668, filed on Feb. 29, 2008.

(51) Int. Cl. B01L 3/02; C08L 1/10; B01D 29/00; C08L 23/06; C08B 11/08; C08L 1/04; C08J 9/28

(52) U.S. Cl. 422/513; 252/182.12; 521/64; 536/95; 210/490

(57) ABSTRACT

A porous article of manufacture (a sealing material) which comprises sintered hydroxyalkylcellulose, for example, sintered hydroxypropylcellulose, or a sealing material which is capable of being formed into a porous article in the form of a filter and which is made by heating at least one gelling agent that has carboxyl functionality and at least one gelling agent that has hydroxyl functionality, preferably carboxylmethylcellulose (CMC) and hydroxypropylcellulose (HPC) respectively, and a method for preparing the same from a powdery admixture thereof, and a pipette which includes the sealing material in the form of a filter, and also including embodiments of a bilayer filter and of a trilayer filter, each of which comprises a composite of a filter of the present invention and a filter comprising porous sintered polyethylene, preferably ultra high-molecular weight polyethylene.

### CROSS-REFERENCE TO RELATED APPLICATION

This application claims the benefit of the filing date of U.S. provisional application No. 61/067,668, filed Feb. 29, 2008.

### FIELD OF THE INVENTION

The present invention relates to a porous sealing material, that is, a material which is normally pervious to the flow of fluids through it, including the ready flow of gas, but which when contacted by liquid becomes impervious to the flow of gas and/or liquid.

The sealing material of the present invention will be described initially in connection with its use as a filter positioned in a pipette; it can be used effectively, however, in other applications, as described hereinafter.

A pipette is an instrument which is used generally to transport initially a measured amount of a fluid, for example, a liquid from a container holding the liquid to another site where it is released from the pipette for its intended use. Although pipettes are made in various designs, they basically comprise a hollow transparent tube which typically is made of glass or plastic and which is open at both ends. One end of the tube is tapered and is generally referred to as the “pipette tip”. The other end of the pipette (also open-ended) receives liquid which is drawn into the pipette through its open-ended tip from a container which holds the liquid to be transported. The “other” end of the pipette is variously referred to as the liquid-holding chamber or the head space; it can comprise a relatively large bulb which is calibrated to hold a predetermined amount of the liquid or it can be uniform in diameter (straight-walled) and have calibrated markings which identify the particular amount of liquid that is drawn into the liquid-holding chamber, for example, 10 ml, 15 ml, and 20 ml volume. Liquid is drawn into the pipette by inserting the pipette tip into a relatively large volume of liquid and drawing up the liquid into the liquid-holding chamber by vacuum (suction) which is applied through the opening of the other end of the pipette. The vacuum can be applied by an individual (pipettor) who sucks the liquid into the pipette or by a mechanical device, for example, a device which displaces air by use of a moving piston. Various types of mechanical devices which function to create a vacuum for use with pipettes are well known.

Irrespective of how the vacuum is applied, there is a risk of contamination by the liquid being transported. For example, experience has shown that, during transport, the liquid can vaporize and form liquid droplets (referred to as the “aerosol effect”) which are transported by air which is being drawn out of the pipette where they can come into contact with the pipettor or the “vacuum-forming” device. This can have adverse consequences on the operation.

The present invention relates to means for which are effective in deterring contamination during the transfer of liquid by use of a pipette or by other means.

### Reported Developments

The prior art discloses various developments in which a filter is positioned in a pipette for the purpose of preventing contamination during use of the pipette.

U.S. Pat. No. 3,982,538 to Sharpe discloses a pipette or other medical equipment having associated therewith a safety valve which is described as permitting the passage of gas, but not permitting the passage of liquid. The valve is described as being constructed from a hollow tube or other container packed with granular or powdered polymeric material which allows moist air or other gas to pass through, but which swells when contacted with liquid, for example, water, to block the further passage of air and/or liquid and thereby prevent contamination of the equipment. Examples of such polymeric material include gelatin, sodium alginate, agar, starch and cellulose derivatives, for example, sodium carboxymethylcellulose.

International Publication No. WO 87/00439 to Ferri discloses a filter/valve which is designed top keep body liquids from contaminating a vacuum source which is used in an aspirating system that is capable of removing surgical liquids that collect at the site of an operational wound and transporting the liquids to a container The filter/valve permits the passage of gas through it, but does not permit the passage of liquids. The filter/valve comprises a porous highly water-absorbent material (absorbent) through which gas can flow, but which, upon contact with a liquid, for example, water, expands to close off the pores of the filter/valve to the extent that the absorbent becomes impervious to the passage of gas and liquid. Examples of the absorbent are graft copolymers which are made from starch and acrylonitrile. In preferred form, the absorbent is mixed with a carrier, for example, polyethylene, and the resulting mixture is placed into a mold and heated under pressure. Upon cooling, a solid porous filter/valve is obtained.

U.S. Pat. No. 4,999,164 to Puchinger et al discloses that the pipette described therein has a filter which is capable of preventing contamination of the device by absorbing aerosol droplets and solid particles, for example, bacteria, fungi, and fungal spores. The filter may be mounted either in the space above the pipette tip or in the bottom of the tip of the pipette. In a preferred embodiment, the filter is multilayer and composed of a number of superimposed discs of different filtering characteristics. A preferred disc material is sintered diatermite guhr. In another preferred embodiment, the filter has labyrinth-like passages or channels and baffle surfaces which trap aerosol droplets and solid particles. Preferred labyrinth-forming materials include polyester, acetate, and cellulose fibers. The filter may be coated with a bactericidal or disinfecting agent or with an adhesive to trap solid particles. The filter surface may also be hydrophobic, for example, a silanized surface.

The pipette which is described in U.S. Pat. No. 5,156,811 includes a plug of porous hydropholic material which is described as being effective in preventing contamination of the suction system associated with the pipette by preventing droplets of vaporized liquid from being drawn into the suction system. The patent explains that the source of the droplets is the vaporization of some of the liquid (an aerosol effect) which is drawn into pipette. Polyethylene is an example of a material from which the porous plug can be made. The pores of the plug contain a hydrophilic material in the form of solid particles which are smaller in size than the pores of the plug and are distributed through most of the pores. The hydrophilic material is described as being liquid scavenging and comprises, for example, cellulose gum. The patent discloses that as “aerosol” droplets are drawn into the plug member, the particles absorb the liquid of the droplets which would otherwise flow into and contaminate the suction system.

U.S. Pat. No. 5,851,491 to Moulton discloses a pipette having therein a filter which is described as being effective in preventing contamination during use. The filter is composed of cylindrical microfibers that are aligned lengthwise and packed together so that the interstitial spaces between the microfibers form channels or pores. Each microfiber consists of a core of an autoclavable material, preferably polypropylene, and an outer coating of a hydrophobic material, preferably polyethylene. Another preferred outer coating is an acid-balanced polyester which changes color on contact with water. The diameters of the pores of the filter are described as being small enough (preferably less than 3 micrometers) to prevent the passage of liquid and aerosol droplets through the filters.

The present invention provides an improved porous sealing material which can be used, for example, as a filter in a pipette to provide various advantages relative to prior art materials.

### BRIEF DESCRIPTION OF THE INVENTION

In accordance with this invention, there is provided a porous article of manufacture (a sealing material) which comprises sintered hydroxyalkylcellulose. In preferred form, the sealing material comprises sintered hydroxyloweralkylcellulose, most preferably sintered hydroxyproplycellulose.

In accordance with another aspect of the present invention, there is provided a pipette having therein a filter comprising the sealing material of the present invention.

Another aspect of the present invention is the provision of a solid sealing material which is capable of being formed into a porous article in the form of a filter and which is made by heating at least one gelling agent that has carboxyl functionality and at least one gelling agent that has hydroxyl functionality. In preferred form, the gelling agent with carboxyl functionality consists essentially of carboxylmethylcellulose (CMC) and the gelling agent with hydroxyl functionality consists essentially of hydroxypropylcellulose (HPC). Preferably, a powdery admixture, in which the gelling agents are dispersed substantially uniformly with each other, is heated to a temperature sufficiently high and for a period of time sufficient to fuse the gelling agents; thereafter the fused product is cooled to form the aforementioned solid material which, in powdery form, is sinterable.

Still another aspect of the present invention is the provision of a bilayer filter which is a composite of a filter of the present invention and a prefilter which comprises preferably porous sintered polyethylene, more preferably ultra high-molecular weight polyethylene (UHMWPE).

An additional aspect of the present invention is the provision of a trilayer filter which is a composite of a filter of the present invention sandwiched between a prefilter and a postfilter, each of which comprises preferably porous sintered polyethylene, more preferably ultra high-molecular weight polyethylene.

### BRIEF DESCRIPTION OF THE DRAWINGS

FIG. 1 is a vertical cross-sectional view of a pipette which shows a filter of the present invention positioned in the tip of the pipette.

FIG. 2 is a vertical cross-sectional view of a pipette which shows a bilayer filter of the present invention positioned in the tip of the pipette.

FIG. 3 is a vertical cross-sectional view of a pipette which shows a trilayer filter of the present invention positioned in the tip of the pipette.

### DETAILED DESCRIPTION OF THE INVENTION

Speaking generally, the present invention comprises a porous sealing material, that is, a material which permits the ready flow of gas through it, but which when contacted by liquid becomes impervious to the flow of gas and/or liquid.

The sealing material of the present invention comprises sintered hydroxyalkylcellulose, preferably a lower alkyl (C₁ to C₆) form of the cellulose, most preferably hydroxypropylcellulose (HPC). It can be prepared, for example, by placing a sinterable powdery form of the “cellulose” in a suitable mold and heating the powdery form under conditions which convert the particles of the powder to a porous solid mass which has, for example, the shape of a filter. Hydroxyalkylcellulose and species thereof are known materials. In preferred form, the sealing material of the present invention is hydrophilic.

HPC itself is a well known and widely available material; it is a popularly used gelling agent. The sealing material or a filter formed therefrom can be made substantially entirely from sintered HPC, for example, at least 98 wt. % HPC. In preferred form, the aforementioned cellulose, which has hydroxyl functionality, is heated in admixture with at least one other gelling agent which has carboxyl functionality to form a product which is capable of being converted into a powdery sinterable material which can be molded and fused into a filter of the desired shape. Examples of gelling agents which have carboxyl functionality are alginic acid and sources of alginic acid, for example, sodium, potassium, ammonium and calcium alginate. A mixture of two or more of such gelling agents can be used.

In its most preferred form, the powdery sinterable material is the reaction product of HPC and carboxymethylcellulose (CMC), for example, sodium CMC, also know for use as a gelling agent.

The proportion of the hydroxyl-containing and carboxyl-containing reactants that are used to form the aforementioned product formed from the reactants will vary depending on the particular reactants used and various other conditions. In general, the admixture of the reactants will comprise about 5 to about 75 wt. % of the “carboxyl” reactant and about 25 to about 95 wt. % of the “hydroxyl” reactant; a preferred mixture comprises about 50 to about 75 wt. % of the “carboxyl” reactant and about 25 to about 50 wt. % of the “hydroxyl” reactant.

The solid sinterable material (sealing material) from which the filter is formed can be prepared in various ways. In preferred form, a powdery mixture of the solid, water-soluble reactants is dissolved in water to form an aqueous solution of the reactants and the solution is heated under conditions which form a reaction product which in powdery form is a sinterable material. The particular reaction conditions used will depend, for example, on the particular reactants used and the amounts thereof comprising the admixture of reactants. It is believed that it will be advantageous to heat the aqueous solution under pressure. In forming the sinterable solid material from CMC and HPC, it is suggested that the aqueous solution of the reactants be heated at a temperature of about 200 to about 300° F. under a pressure of about 15 to about 30 psi for a period of time of about 30 to about 60 minutes. The solid reaction product can be recovered from the liquid solution by evaporating the liquid at a suitable elevated temperature, for example, about 160 to about 200° F. for a period of time of about 6 hrs. to about 24 hrs.

The resulting dried solid mass of material can then be broken into pieces which are ground to a suitable mesh size, for example, −20 mesh. The mesh size will determine pore size and flow rates.

The resulting sinterable powdery form of the aforementioned reaction product can be placed in a suitable mold which is heated to a temperature sufficiently high and for a period of time sufficient to cause the particles of powder to coalesce into a porous solid mass in the desired shape of the filter. The temperature/time conditions will vary depending, for example, on the particular nature of the aforementioned sinterable reaction product and the particular temperatures and time periods that are used; for example, the higher the temperature, the shorter the time period. Exemplary molding conditions involve a temperature of about 350 to about 430° F. and a period to time of about 12 to about 20 minutes.

Another exemplary method that can be used to form the solid sinterable material from which the filter is formed is described hereafter. The “carboxyl” and “hydroxyl” reactants in powdery form are mixed to form a substantially uniform dispersion of the reactants. The resulting admixture of reactants is heated to a temperature sufficiently high and for a period of time sufficient to fuse the reactants. The particular fusing conditions will vary depending, for example, on the particular reactants used and the amounts thereof and the involved temperature. Exemplary conditions are the use of a temperature of about 350 to about 400° F. and a period of time of about 15 to about 30 minutes.

Upon cooling, the resulting porous sinterable solid mass of coalesced particles can be broken up and then ground to a suitable particle size, for example, through a 20 mesh screen as mentioned above. A filter can be formed from the resulting sinterable powder in the manner described above.

In another embodiment of the invention, the filter comprises sintered particles of the aforementioned sinterable material (referred to hereafter as “sealing material”) and another sinterable material which functions to improve the physical and/or chemical properties of the filter or which functions as a filter. Polyolefins, particularly polyethylenes, are preferred examples of such materials; poplyethylene is preferred particularly. Ultra high-molecular weight polyethylene (UHMWPE) is the preferred polyethylene, that is, polyethylene having a molecular weight of at least about 5 million and ranging up to about 12 million.

Other polyethylenes can be used, for example, high density polyethylene, that is, polyethylenes having fractional melt flow, for example, a melt index less than one. Relatively low molecular weight polyolefins including polyethylenes, whose molecular weight can be increased by chemical modification such as, for example, irradiation and peroxide treatment of the polymer, can be used also.

The proportion of sealing material and other sinterable material comprising the filter will depend, for example, on the particular materials used and the desired properties of the filter. Speaking generally, the filter can comprise about 10 to about 30 wt. % of the sealing material and about 70 to about 90 wt. % of the other sinterable material, for example, polyethylene. It is believed that the more widely used filters will comprise about 10 to about 20 wt. % of the sealing material and about 80 to about 90 wt. % of the other sinterable material.

A filter comprising the aforementioned sinterable materials can be made by molding and fusing a mixture of particles of the materials at elevated temperature in a suitable mold, for example, at a temperature of about 350 to about 430° F. and a period of time of about 12 to about 20 minutes.

The filter of the present invention can be formed also from the aforementioned sinterable material(s) which include admixed therewith one or more additives which are present in relatively small amounts, for example, about 0.5 to no greater than about 10 wt. %. Examples of such additives include plasticizers and antistatic agents.

The porosity of the filter of the present invention can be controlled in accordance with known techniques to provide a porous filter which functions appropriately to accommodate the particular use of the filter, for example, the nature of the liquid which is drawn into the pipette. Speaking generally, it is believed that filters that will be used widely will have a porosity of about 10 to about 40 microns pore size and a pore volume of about 20 to about 50%.

### DESCRIPTION OF THE DRAWINGS

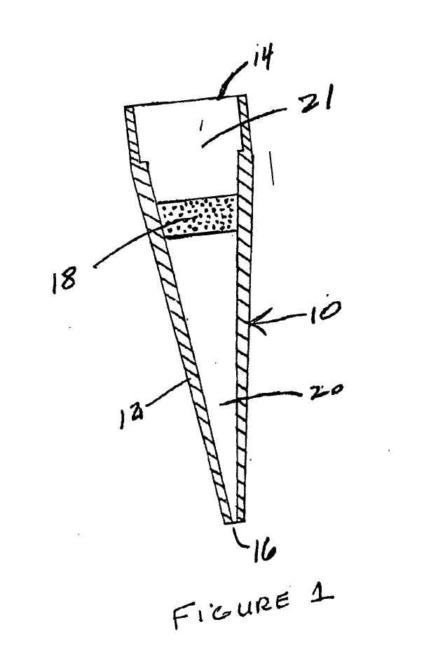

FIG. 1 illustrates a pipette tip 10 for drawing and dispensing liquid samples according to an embodiment of the invention. The pipette tip 10 comprises a tapering, hollow tubular member 12 of inert material, for example, polypropylene or polyethylene, open at the upper and lower ends, 14 and 16, respectively, and equipped with a filter 18 of the present invention. The filter is sufficiently porous to allow gas to pass therethrough, but upon being contacted with liquid, it becomes impervious to liquid flow. The filter is fitted (for example, force fit) toward the upper end 14 of the tip 10, thereby defining a liquid sample reservoir 20 below the filter 18 and a head space 21 above the filter 18. The upper end 14 of the hollow tubular member 12 may be releasably secured to a suitable suction/delivery device (not shown) in a manner known in the art.

Ideally the drawn liquid sample (not shown) does not completely fill the liquid sample reservoir 20, but allows for an air space below the filter 18. If the drawn sample accidently contacts the filter 18, the liquid is prevented from passing through the filter, thereby protecting the suction/delivery device from contamination.

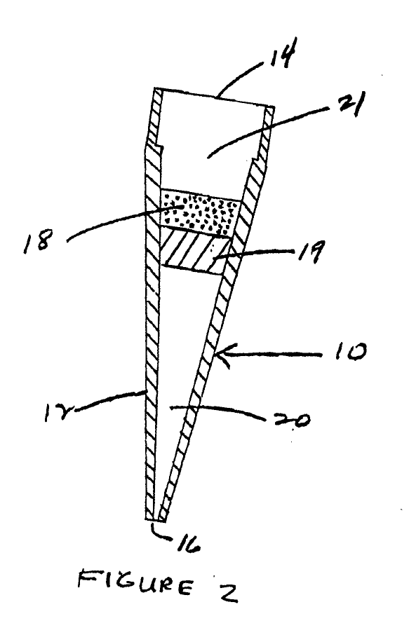

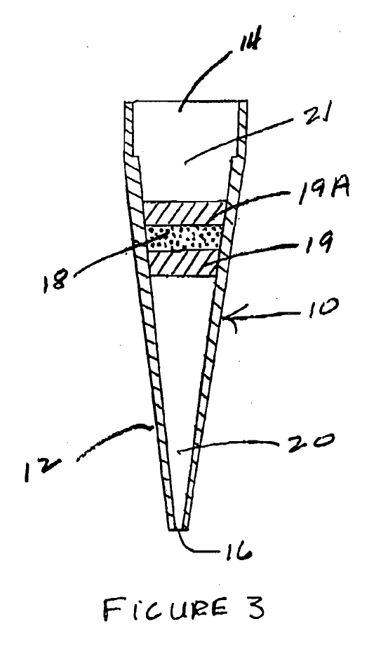

The pipette tip of FIGS. 2 and 3 are like the pipette tip of FIG. 1, but are different in that they are equipped with different embodiments of the filter of FIG. 1, as described below.

With reference to the drawings, FIG. 2 shows another embodiment of the present invention in which a filter 18 of the present invention comprises a composite which includes a prefilter 19; similarly, FIG. 3 shows still another embodiment of the present invention in which a filter of the present invention comprises a composite which includes both a prefilter 19 and a postfilter 19A. Each of the prefilter and postfilter comprises porous sintered polyethylene, preferably, ultra high molecular weight polyethylene (UHMWPE) and is bonded to the filter of the present invention. Preparation of the embodiment of FIG. 2 is described in Example No. 2 hereafter where it is referred to as a “bilayer filter”. Preparation of the embodiment of FIG. 3 is described in Example No. 3 hereafter where it is referred to as a “trilayer filter”. The use of the sintered polyethylene filter in combination with the filter of the present invention can be advantageous in applications in which there may be a tendency for one or more materials to be leached from the filter of the present invention as a result of contact with the liquid drawn into the pipette tip; the leached material becomes trapped in the polyethylene filter. Also, the polyethylene filter functions to offset or eliminate the effects of the surge of liquid flow.

As mentioned above, the filter of the present invention can be used in applications other than just a “pipette” application. Examples of such applications include its use in intravenous sets, collection bags (for example, for urine, and blood), column chromatography and in a blood gas collector.

The filter is effective when contacted with a variety of types of liquids, for example: aqueous solutions of various types, for example, blood and other bodily fluids; pure alcohol and alcohol-based solutions, hydrocarbon solvents, and bacteriacides. One important characteristic of the filter is that it is capable of releasing readily various types of liquid when the apparatus in which it is used is in the discharge mode.

### EXAMPLES

The following examples are illustrative of the practice of the present invention.

### Example No. 1

This example is illustrative of the preparation of a filter according to the present invention; the filter is made from carboxymethylcellulose (CMC) and hydroxypropylcellulose (HPC).

CMC powder (about 75 g) and HPC powder (about 25 g) are mixed with 5 L of distilled water until a homogeneous solution is achieved. The aqueous solution is stirred and heated to about 250° F. in a low-pressure reactor at about 30 psi for about 60 min in order to react the materials. After cooling and thereafter releasing the pressure, the solution is poured onto a TEFLON®-coated cooling tray to a depth of about ½ inch and dried in an oven at about 160° F. for about 24 hours to evaporate the water. After cooling, the dried solid material is broken up and ground into a powder of a mesh size of about minus 20, which is suitable for molding into a filter.

A mold is prepared by forming a cavity in a metal plate, the cavity so dimensioned as to provide a filter suitable for insertion into a pipette tip, as shown in FIG. 1. The aforementioned powder is poured into the mold and compacted by vibration. The mold is placed in a preheated vacuum oven at about 370° F. and a vacuum of about 22 inches of mercury for about one minute. Nitrogen is then introduced into the oven in order to facilitate heat-transfer and to minimize oxidation. The mold is held at about 370° F. for about 12 minutes in order to fuse the particles together. The mold is removed from the oven and cooled to about 100° F. The filter is removed from the mold and allowed to cool completely.

### Example No. 2

This example is illustrative of the preparation of a bilayer filter according to the present invention and consists of a prefilter and a main filter; the prefilter is made from ultrahigh molecular weight polyethylene (UHMWPE) powder and the main filter is made from the aforementioned powder of Example No. 1 (carboxymethylcellulose (CMC) and hydroxypropylcellulose (HPC)).

The method of Example No. 1 is followed using a 2-part stacked mold. The first section of the mold is filled with UHMWPE powder, having a molecular weight in the range of about five million to about twelve million. The second section of the mold is installed and filled with the CMC/HPC powder of Example No. 1. The mold is processed as in Example No. 1 and includes heating at about 370° F. for about 12 minutes in order to fuse the material. After cooling and unmolding, a bilayer filter having a prefilter of polyethylene and a main filter of CMC/HPC is obtained.

### Example No. 3

This example is illustrative of the preparation of a trilayer filter according to the present invention and consists of a prefilter, a main filter and a postfilter; the prefilter and postfilter are made from ultrahigh molecular weight polyethylene (UHMWPE) and the main filter is made from the aforementioned powder of Example No. 1 (carboxymethylcellulose (CMC) and hydroxypropylcellulose (HPC)).

The method of Example No. 2 is followed using a 3-part stacked mold. The first section of the mold is filled with UHMWPE powder having a molecular weight in the range of about five million to about 12 million. The second section of the mold is installed and filled with the CMC/HPC powder of Example No. 1. The third section of the mold is installed and filled with the same polyethylene powder as was used in the first section of the mold, that is, UHMWPE. The mold is processed as in Example No. 2 and includes heating at about 370° F. for about 12 minutes in order to fuse the particles of powder. After cooling and unmolding, a composite filter comprising a trilayer filter having a prefilter of polyethylene, a main filter of CMC/HPC, and a postfilter of polyethylene is obtained.

Filters of the present invention can be made in various sizes, for example, having a diameter of about 1/16″ to about one inch and a length of about 0.020″ to about one inch or more.

1. A solid porous sealing material which is capable of being formed into a filter and which comprises sintered hydroxyalkylcellulose.

2. A pipette having therein a filter comprising the sealing material of claim 1.

3. A solid porous sealing material which is capable of being formed into a porous article in the form of a filter and which is made by heating at least one gelling agent which has carboxyl functionality and at least one gelling agent which has hydroxyl functionality.

4. A material according to claim 3 in which the gelling agent with carboxyl functionality consists essentially of carboxylmethylcellulose (CMC) and the gelling agent with hydroxyl functionality consists essentially of hydroxypropylcellulose (HPC).

5. A material according to claim 4 prepared by heating a powdery admixture in which the CMC and HPC are dispersed substantially uniformly with each other.

6. A material according to claim 5 wherein the admixture is heated to a temperature sufficiently high and for a period of time sufficient to fuse the CMC and HPC in the admixture and thereafter cooling the fused product to the solid material which in powdery form is sinterable.

7. A material according to claim 4 which is made by heating an aqueous solution of the CMC and HPC at a temperature and pressure and for a period of time sufficient to form a product which in powdery form is a sinterable material and thereafter recovering the product in solid form by evaporating the liquid of the aqueous solution.

8. A filter comprising a sintered solid material of claim 6.

9. A filter comprising a sintered solid material of claim 7.

10. A filter of claim 9 prepared by molding a powdery form of the sinterable material at a temperature sufficiently high and for a sufficient period of time to fuse the powdery form of the material into a fused porous product and thereafter cooling the fused product to form the filter.

11. A filter according to claim 9 comprising also polyethylene.

12. A filter according to claim 11 in which the polyethylene consists essentially of ultra high-molecular weight polyethylene.

13. A composite bilayer filter comprising a filter formed from the sealing material of claim 1 and a polyethylene filter bonded thereto.

14. A composite bilayer filter comprising a filter formed from the sealing material of claim 3 and a polyethylene filter bonded thereto.

15. A composite trilayer filter comprising a filter formed from the sealing material of claim 1 and bonded to and sandwiched between two polyethylene filters.

16. A composite trilayer filter according to claim 15 in which the polyethylene filters comprise UHMW polyethylene.

17. A pipette tip having therein a filter comprising the sealing material of claim 3.

18. A pipette tip having therein a bilayer filter according to claim 13, and positioned in the pipette tip so that the polyethylene filter faces the lower end of the tip.

19. A method for preparing a porous sealing material comprising heating hydroxyalkylcellulose in powdery form under conditions which convert the particles of the powder to a porous solid mass.

20. A method for preparing a porous sealing material comprising heating an aqueous solution of a gelling agent which has carboxyl functionality and a gelling agent which has hydroxyl functionality under conditions which form a product which in powdery form is a sinterable material and recovering the product from the aqueous solution after evaporating the water of the solution.
